(19) United States
(12) Patent Application Publication
(10) Pub. No.: US 2017/0068399 A1
(43) Pub. Date: Mar. 9, 2017

(54) USER-RELATED INFORMATION DISPLAY USER TERMINAL, USER-RELATED INFORMATION DISPLAY SYSTEM, USER-RELATED INFORMATION DISPLAY METHOD, AND PROGRAM FOR USER-RELATED INFORMATION DISPLAY USER TERMINAL

(71) Applicant: OPTiM Corporation, Saga (JP)

(72) Inventor: Shunji SUGAYA, Tokyo (JP)

(21) Appl. No.: 14/845,469

(22) Filed: Sep. 4, 2015

(51) Int. Cl. G06F 3/0482; H04L 12/58; H04L 29/08

(52) U.S. Cl. CPC G06F 3/0482; H04L 67/306; H04L 67/18; H04L 51/28

(57) ABSTRACT

The present invention is to display user-related information according to a phone number, a search condition, a location, and a time. The user-related information display system 1 centrally manages user-related information in the user-related information database 250 of the reference server 200 and enables a user terminal 10 storing a user identifier list to search user-related information by a user identifier and search user-related information satisfying a user-related information search condition such as a specific term or location information, so as to display the user-related information containing, a real-time element, and interactive element, and a personal element.

### TECHNICAL FIELD

The present invention relates to a user-related information display user terminal, a user-related information display system, a user-related information display method, and a program for the user terminal.

### BACKGROUND ART

Recently, various services have been provided to users by connecting mobile terminals to web servers, etc., through a public network. In particular, a high functional mobile terminal provided with a call function is called smart phone terminal. Many people are using a smartphone instead of a conventional mobile phone.

The user records and manages information such as contact information and shop information associated with the user on a smart phone to effectively advertise the user itself. However, it takes a great deal effort to maintain and share the latest user information varying from time to time.

For approaching such problems, a method in which a user transmit the profile information updated by the user itself to the communication terminals of other users, the profile information of which is not registered in the user's own terminal.

### CITATION LIST

### Patent Literature

Patent Document 1: JP 2013-12164 A

### SUMMARY OF INVENTION

Patent Document 1 discloses the method of specifying the terminal identifier information and the update rule which are associated with the updated self-profile information and stored in the self-information management table to transmit the update information to a user's communication terminal registering the pre-update profile information of an updater as profile information of others in the address book, as the destination of updated self-profile information, when the update rule is one way update.

But in the method disclosed in Patent Document 1, the other communication terminals sharing the latest profile need to be registered in the communication terminal of the profile updater. In particular, it is difficult to manage a list because the list does not include the other parties whose latest profiles are not necessary for a user but includes the other parties who need the latest profile of a user. Additionally, since the latest profile is not centrally managed, the communication necessary for updating the profile starts from the communication terminal. As the amount of the other party list to be updated is increased, the traffic volumes required for the update may be voluminously accumulated and become huge.

Accordingly, an objective of the present invention is to provide a user-related information display user terminal, a user-related information display system, a user-related information display method and a program for the user terminal, which use a reference server to centrally manage the user-related information and to enable a user terminal storing a user identifier list to search user-related information by a user identifier or user-related information satisfying a user-related information search condition, so as to display the user-related information.

According to the first aspect of the present invention, a user terminal provided with a memory unit storing a user list and communicatively connected with a reference server provided with a user-related information database, includes:

an identifier acquisition unit acquiring one or more user identifiers from the user list;

a user-related information acquisition unit acquiring user-related information associated and stored with the acquired identifiers or user-related information satisfying a user-related information search condition from the reference server; and

a user-related information display unit outputting the acquired user-related information to the display unit.

According to the first aspect of the present invention, a user terminal provided with a memory unit storing a user list and communicatively connected with a reference server provided with a user-related information database acquires one or more user identifiers from the user list, acquires the user-related information associated and stored with the acquired identifiers or user-related information satisfying a user-related information search condition from the reference server; and outputs the acquired user-related information to the display unit.

The first aspect of the present invention is the category of a user-related information display user terminal, but the categories of a user-related information display method and a program for the user terminal have the same functions and effects.

According to the second aspect of the present invention, the user terminal according to the first aspect of the present invention includes:

an identifier storing unit storing the identifier in the user list in the case in which the identifier associated with the acquired user-related information is not stored in the user list.

According to the second aspect of the present invention, the user terminal according to the first aspect of the present invention stores the identifier in the user list in the case in which the identifier associated with the acquired user-related information is not stored in the user list.

According to the third aspect of the present invention, the user terminal according to the first or the second aspect of the present invention, in which the user list is an address book previously provided in the user terminal, and the identifier is any one of a name, a phone number, and an e-mail address associated and stored with the user.

According to the third aspect of the present invention, in the user terminal according to the first or the second aspect of the present invention, the user list is an address book previously provided in the user terminal, and the identifier is any one of a name, a phone number, and an e-mail address associated and stored with the user.

According to the fourth aspect of the present invention, the user terminal according to any one of the first to the third aspects of the present invention, further includes:

a location information acquisition unit;

a display condition acquisition unit acquiring a display condition containing at least one of a location and a time previously set for each user-related information;

a display condition determination unit determining if the location of the user terminal and the current time satisfies the display condition, in which

the user-related information display unit outputs the user-related information to the display unit only when the display condition is satisfied.

According to the fourth aspect of the present invention, the user terminal according to any one of the first to the third aspects of the present invention further includes a location information acquisition unit, acquires a display condition containing at least one of a location and a time previously set for each user-related information, determines if the location of the user terminal and the current time satisfies the display condition, and outputs the user-related information to the display unit only when the display condition is satisfied.

According to the fifth aspect of the present invention, a user-related information display server includes a user terminal provided with a memory unit storing a user list and a reference server provided with a user-related information database, the user terminal being communicatively connected with the reference server, in which

the user terminal includes:

an identifier acquisition unit acquiring one or more user identifiers from the user list;

a user-related information acquisition unit acquiring the user-related information associated and stored with the acquired identifiers or user-related information satisfying a user-related information search condition from the reference server; and

a user-related information display unit outputting the acquired user-related information to the display unit; and

the reference server includes:

an extract parameter acquisition unit acquiring an extract parameter of the user-related information from the user terminal;

a user-related information extracting unit extracting user-related information from the user-related information database based on the acquired extract parameter; and

a user-related information transmitting unit transmitting the extracted user-related information to the user terminal.

According to the fifth aspect of the present invention, in user-related information display system including a user terminal provided with a memory unit storing a user list and a reference server provided with a user-related information database, the user terminal being communicatively connected with the reference server, the user terminal acquires one or more user identifiers from the user list, acquires the user-related information associated and stored with the acquired identifiers or user-related information satisfying a user-related information search condition from the reference server, and outputs the acquired user-related information to the display unit, and the reference server acquires an extract parameter of the user-related information from the user terminal, extracts user-related information from the user-related information database based on the acquired extract parameter, and transmits the extracted user-related information to the user terminal.

According to the sixth aspect of the present invention, a user-related information display method executed by a user terminal provided with a memory unit storing a user list and communicatively connected with a reference server provided with a user-related information database, includes the steps of;

acquiring one or more user identifiers from the user list;

acquiring the user-related information associated and stored with the acquired identifiers or user-related information satisfying a user-related information search condition from the reference server; and

outputting the acquired user-related information to the display unit.

According to the seventh aspect of the present invention, a computer program product for use in a user terminal provided with a memory unit storing a user list and communicatively connected with a reference server provided with a user-related information database, includes a non-transitory computer usable medium having a set of instructions physically embodied therein, the set of instructions including computer readable program code, which when executed by the user terminal causes the information processing unit to:

acquire one or more user identifiers from the user list;

acquire the user-related information associated and stored with the acquired identifiers or user-related information satisfying a user-related information search condition from the reference server; and

output the acquired user-related information to the display unit.

The present invention provides a user-related information display user terminal, a user-related information display system, a user-related information display method and a program for the user terminal, which use a reference server to centrally manage the user-related information and to enable a user terminal storing a user identifier list to search user-related information by a user identifier or user-related information satisfying a user-related information search condition, so as to display the user-related information.

### BRIEF DESCRIPTION OF DRAWINGS

FIG. 1 shows an overview of the user-related information display system 1.

FIG. 2 shows an overall schematic diagram of the user-related information display system 1.

FIG. 3 shows a functional block diagram of the user terminal 10 and the reference server 200.

FIG. 4 shows a flow chart illustrating the user-related information display process executed by the user terminal 10 and the reference server 200.

FIG. 5 shows an example of the search condition input screen displayed in the user terminal 10.

FIG. 6 shows an example of the user-related information displayed on the screen of the user terminal 10.

FIG. 7 shows an example of the user-related information table in the user-related information database 250 stored in the reference server 200.

### DESCRIPTION OF EMBODIMENTS

Embodiments of the present invention are described below with reference to the attached drawings. However, this is illustrative only, and the technological scope of the present invention is not limited thereto.

### Overview of User-Related Information Display System 1

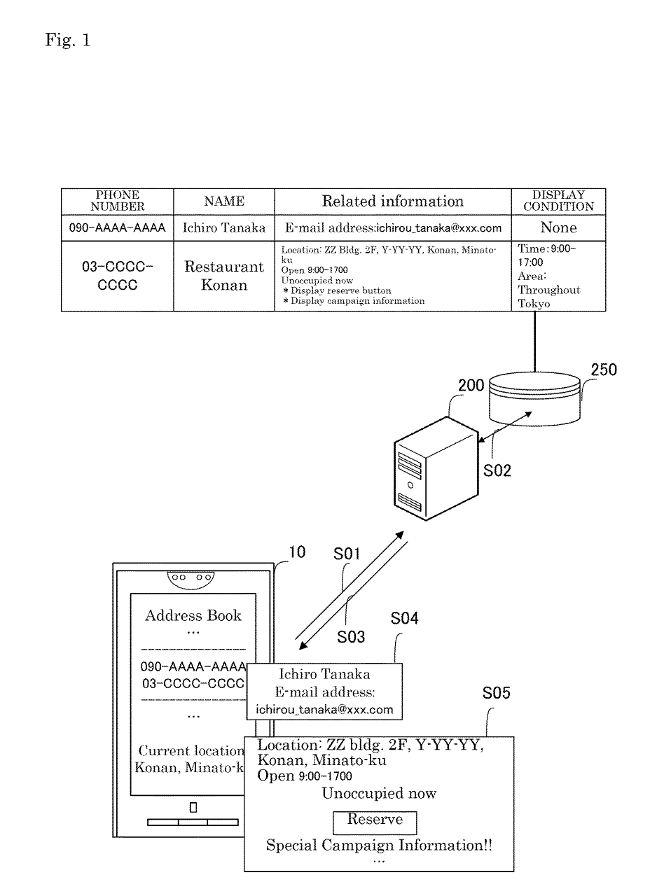

FIG. 1 shows an overview of the user-related information display system 1 according to a preferred embodiment of the present invention. The overview is described below with reference to FIG. 1.

The user terminal 10 is provided with a user list such as an address book in the memory unit. The user terminal 10 transmits a request of the user-related information to the reference server 200 when a user opens the address book or instructs a search. (Step S01).

This request contains a parameter for the search. The user-related information matched with the parameter is transmitted from the reference server 200. The parameter may be an identifier such as a phone number and a user name, a term such as “steak” or “100-yen shop,” or location information such as “Minato-ku, Tokyo”

When receiving a request, the reference server 200 acquires a parameter and extracts user-related information matched with the search condition from the user-related information database 250 stored in the memory unit (Step S02). If the parameter is an identifier, a user is extracted by the identifier. If the parameter is “Restaurant,” the user-related information containing the term “Restaurant” is extracted. As long as having an identifier, the user may not necessarily be a human and may be an information provider such as a corporation, a building, a website, and a theme park.

The reference server 200 transmits the extracted user-related information to the user terminal 10 (Step S03). FIG. 1 shows the result of transmitting a request with parameters as the phone numbers “090-AAAA-AAAA” and “03-CCCC-CCCC” used as identifiers.

The user terminal 10 outputs the received user-related information on the screen (Step S04). The information is shown out of the screen in FIG. 1, which is just for showing overlapping. Moreover, a display condition can be set for the user-related information, in which, for example, “Konan restaurant” is set with a time and a place contained in a display condition. Only when the display condition is satisfied, the user-related information is displayed on the screen (Step S05). This determination may be conducted when the reference server extracts a parameter or after the user terminal receives a parameter.

According to the user-related information, as shown in FIG. 1, a button for the reservation is displayed on the screen. The button is pressed to open a page in cooperation with a web browser or to directly communicate with a reservation system to start the reservation procedure. Moreover, the user-related information is basically updated by the user itself. However, a part of the user-related information may be automatically updated by collecting contents from the specific web server or the Internet, for example, to display the information “Special campaign.”

The user-related information may be an e-mail address or shop information containing a map, a coupon, business hours, and a regular closing day. In the user-related information, a content that can be displayed by identifying the individual who is the owner of the user terminal 10, for example, the latest exchange of messages with the user may be automatically registered. Moreover, the display condition containing a time period is set for only a part of user-related information to display specific information only during, for example, a limited-time sale.

### Configuration of the User-Related Information Display System 1

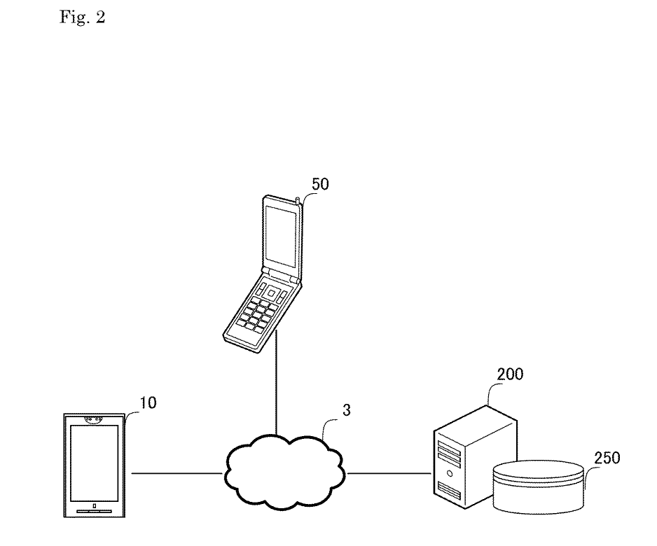

FIG. 2 shows a system configuration diagram of the user-related information display system 1 as a preferred embodiment of the present invention. The user-related information display system 1 includes a user terminal 10, another terminal 50, a reference server 200, a user-related information database 250, and a public line network 3 (e.g., the Internet network, a third generation communication network, and a fourth generation communication network).

The user terminal 10 is communicatively connected with the reference server 200 through a public line network 3. The user-related information database 250 is stored in the memory unit of the reference server 200. The user terminal 10 may be communicatively connected with a public line network 3 through a network device such as a router.

The user terminal 10 may be a general information terminal capable of allowing a user to browses web pages, performing procedures, and making a call, which is an information device or an electrical appliance with the functions to be described later. For example, the user terminal 10 may be a mobile phone, a smart phone, a complex printer, a television, a network device such as a router or a gateway, and a computer. The user terminal 10 may also be white goods such as a refrigerator and a washing machine. The user terminal 10 may also be general information appliances such as a telephone, a netbook terminal, a slate terminal, an electronic book terminal, an electronic dictionary terminal, a portable music player, and a portable player and recorder.

The another terminal 50 is an example of the terminal from which the user terminal 10 acquires user-related information. The another terminal 50 may not necessarily be communicatively connected with the reference server 200. For example, even if the another terminal 50 is a fixed-line phone not connected with the public network 3, the owner of the another terminal 50 only has to be associated with one identifier in the user-related information database 250. A terminal other than the another terminal 50 may be used to register the user-related information in the reference server 200.

The reference server 200 is provided with the user-related information database 250, which transmits the user-related information in response to an inquiry from the user terminal 10.

### Functions

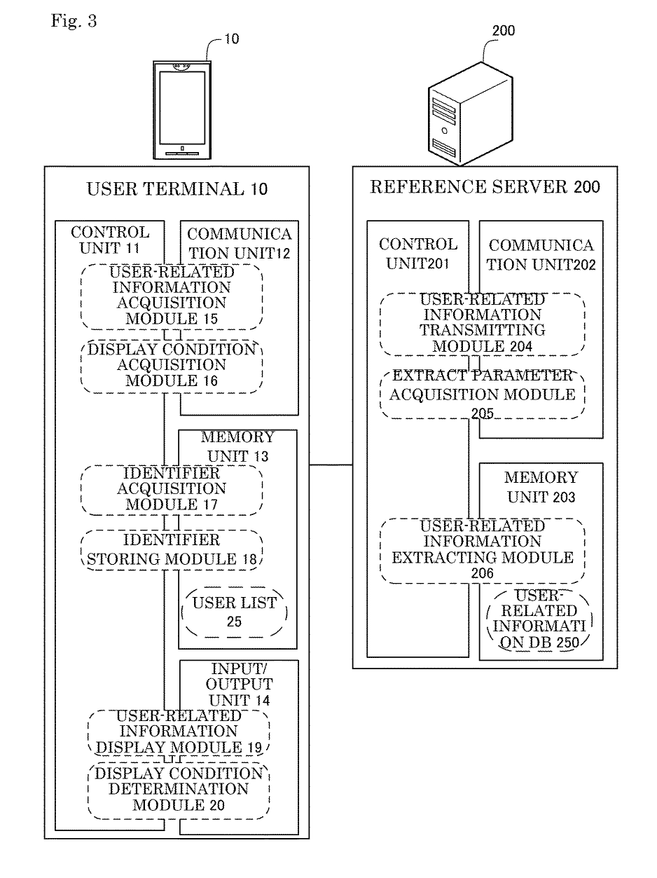

FIG. 3 shows the relationship among the respective functions of the user terminal 10 and the reference server 200.

The user terminal 10 is provided with a control unit 11 including a central processing unit (hereinafter referred to as “CPU”), a random access memory (hereinafter referred to as “RAM”), and a read only memory (hereinafter referred to as “ROM”); and a communication unit 12 including a Wireless Fidelity or Wi-Fi® enabled device complying with, for example, IEEE 802.11, or a wireless device complying with the IMT-2000 standard such as the third generation mobile communication system. The communication unit may include a wired device for LAN connection.

The user terminal 10 is also provided with a storage unit as a memory unit 13 such as a hard disk or a semiconductor memory to store data. Moreover, the user terminal 10 is provided with an input/output unit 14 including a display unit outputting and displaying data and images that have been controlled by the control unit; and also including a touch panel, a keyboard, a mouse, and the like that receive input from a user and a supporter. The user terminal 10 is also is provided with a location information acquisition unit acquiring the current location information of the terminal as a part of the input/output unit 14. The user terminal 10 is provided with a user list 25 in the memory unit 13.

In the user terminal 10, the control unit 11 reads a predetermined program and cooperates with the communication unit 12 to achieve a user-related information acquisition module 15 and a display condition acquisition module 16. The control unit 11 also reads a predetermined program and cooperates with the memory unit 13 to achieve an identifier acquisition module 17 and an identifier storing module 18. The control unit 11 also reads a predetermined program and cooperates with the input/output unit 14 to achieve a user-related information display module 19 and a display condition determination module. 20.

The reference server 200 includes a control unit 201 including a CPU, a RAM, a ROM; and a communication unit 202 including a Wi-Fi® enabled device complying with, for example, IEEE 802.11. The communication unit 202 may include a wired device for LAN connection. The reference server 200 is also provided with a storage unit as a memory unit 203 such as a hard disk or a semiconductor memory to store data. The reference server 200 stores the user-related information database 250 in the memory unit 203.

In the reference server 200, the control unit 201 reads a predetermined program and cooperates with the communication unit 202 to achieve a user-related information transmitting module 204 and an extract parameter acquisition module 205. The control unit 201 reads a predetermined program and cooperates with the memory unit 203 to achieve a user-related information extracting module 206.

### User-Related Information Display Process

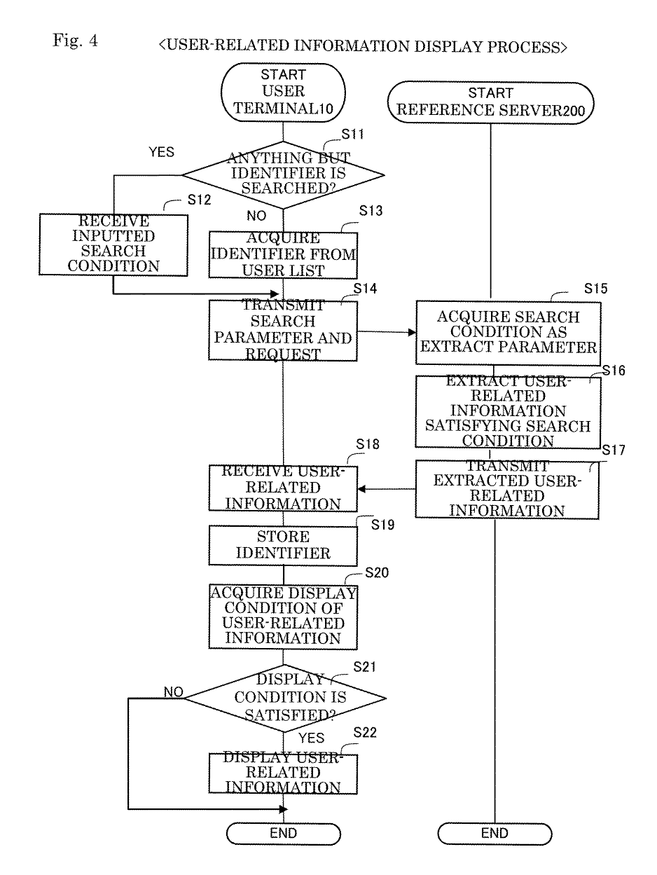

FIG. 4 shows a flow chart illustrating the user-related information display process executed by the user terminal 10 and the reference server 200. The process executed by the modules of the above-mentioned devices is explained together with this process.

First, the user-related information acquisition module 15 of the user terminal 10 acquires user-related information at previously set constant update interval or when a user opens the user list or makes an input. At that time, the user terminal determines whether or not a search parameter anything but an identifier is used for searching user-related information (Step S11). The user list is a set of user information including an identifier. An example of the user list includes an address book but is not limited thereto. The identifier uniquely identifies a user terminal, which may be a phone number, a user name, an e-mail address, etc. The case in which the user list is an address book and in which the identifier is a phone number is described below.

For example, when a search parameter anything but an identifier is used if a user opens the search word input screen (Step S11: YES), the user-related information acquisition module 15 receives an input search parameter (Step S12). The search condition may combine anything but an identifier with an identifier or may be a complex search condition including AND, OR, NOT conditions to obtain an arbitrary result.

On the other hand, when anything but an identifier is searched if a user opens or clicks the address book (Step S11: NO), the identifier acquisition module 17 acquires an identifier from the user list as a parameter (Step S13). The identifier of the parameter may not be limited to one and could be more than two.

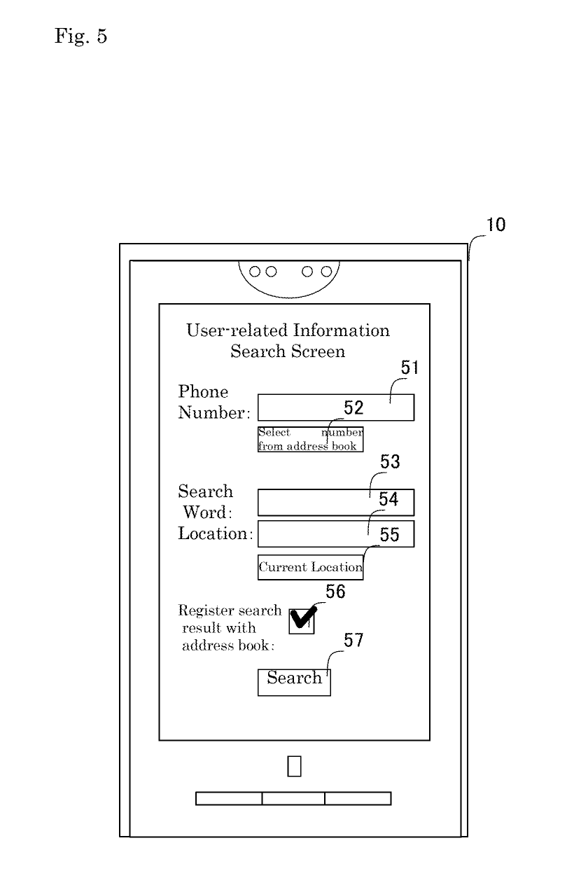

FIG. 5 shows an example of the search condition input screen displayed in the user terminal 10. In addition to the identifier input form 51, the search word input form 53, and the location information input form 54, the screen is provides with a button for selecting a number from the address book, a button for acquiring current location 55, etc. The location information is input for the search, which may not necessarily be used for the display condition described to be later.

The user can start a search by pressing the search button 57. The user can also automatically register the acquired search result in the address book as the user list by selecting the check box 56 in the case in which the result is not registered in the address book. This search screen is displayed in Step S12, and only the user list is displayed in Step S13.

The user-related information acquisition module 15 then transmits a request of the user related information to the reference server 200 together with a search parameter (Step S14). The extract parameter acquisition module 205 of the reference server 200 acquires a search condition as an extract parameter from the received request (Step S15).

The user-related information extraction module 206 of the user profile server 200 extracts user-related information satisfying the condition related to the extract parameter acquired from the user-related information table in the user-related information database 250 stored in the memory unit (Step S17). For example, when the extract parameter is an identifier, user-related information associated and stored with the identifier is extracted. When the extract parameter is a term, user-related information is searched by the term, a co-occurrence word or a synonym of the term, or a word closely related with the term.

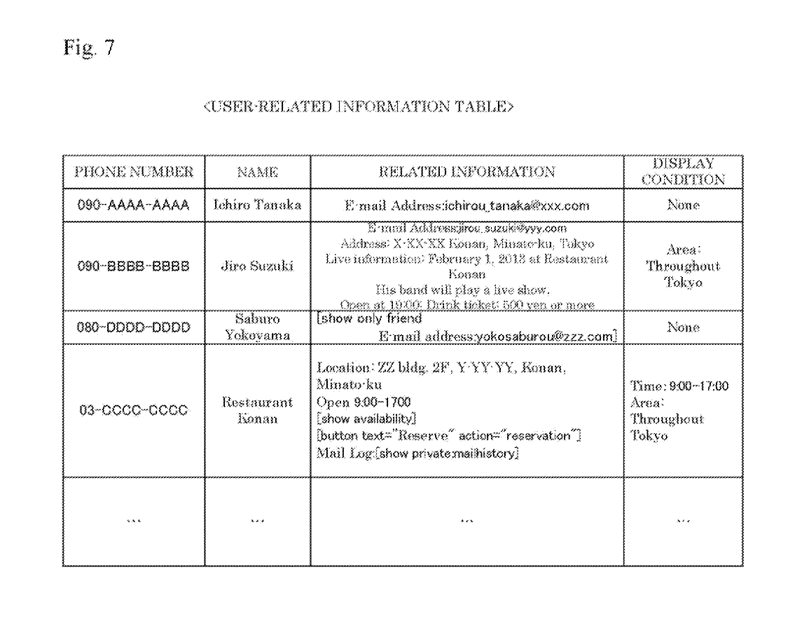

FIG. 7 shows an example of the user-related information table in the user-related information database 250. The user-related information table stores phone numbers, names, related information, and display conditions as identifiers. The row of the phone number is a primary key in the table. One result is obtained from one identifier as one extract parameter as long as the data exists. On the other hand, a number of results may be obtained from one extract parameter such as a term or location information.

As shown in FIG. 7, the related information may contain not only personal information but also information to be advertised. On the other hand, from the viewpoint of privacy, a user can display the personal information to another party as a friend who satisfies a certain criteria, for example, who knows the user's phone number. Additionally, a self-defined specific function may be used to insert vacant seat information, a user form such as a button and personal information such as a mail log.

The user-related information transmitting module 204 of the reference server 200 then transmits the extracted user-related information to the user terminal 10 (Step S17). If not included in the extract parameter, the user-related information search condition is also transmitted. The user-related information acquisition module 15 of the user terminal 10 receives user-related information (Step S18).

If the identifier associated with the received user-related information is not registered in the user list, the identifier storing module 18 may store the identifier in the user list (Step S19). For example, the phone number of the shop acquired as a result of the search may be registered in the address book. This step may be executed in response to an input from a user.

The display condition acquisition module 16 then acquires a display condition for the user-related information from the received data (Step S20). This display condition may be set from the viewpoint of security but originally is rather regarded as a recommendation to raise the value of the information. Therefore, the display condition is preferably set for each content in the case in which the user terminal is not provided with a unit acquiring location information, etc. or in which the user terminal cannot acquire the criteria of the display condition because being temporarily unavailable.

The display condition determination module 20 of the user terminal 10 determines whether or not the current time and the location information satisfies the display condition for the received user-related information (Step S21). If the display condition is not satisfied (Step S21: NO), the user-related information is not displayed. If the display condition is satisfied (Step S21: YES), the user-related information display module 19 displays the user-related information in the display unit (Step S22). When multiple kinds of user-related information satisfying the search condition are received at the same time, Steps S21 and S22 may be executed for each of the multiple kinds of user-related information.

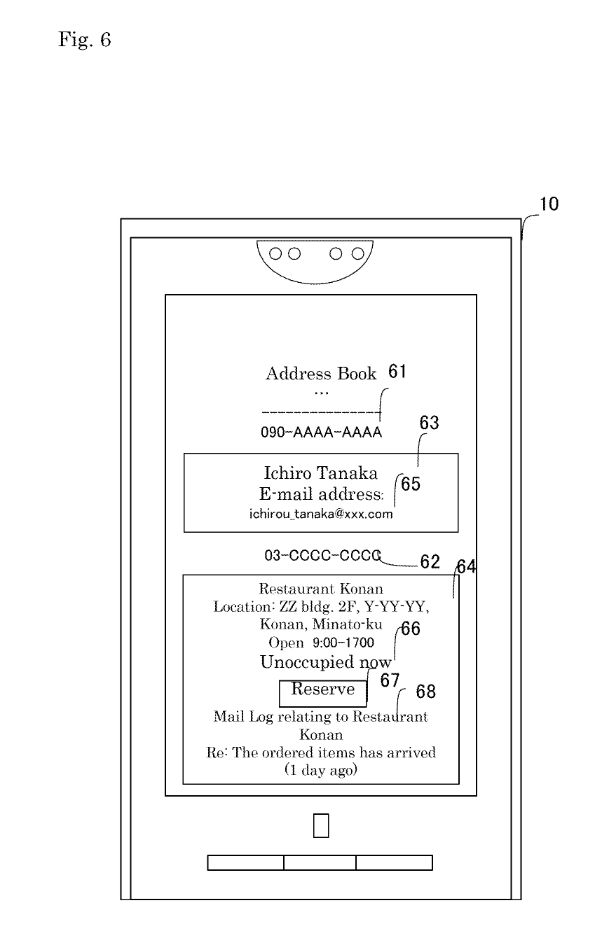

FIG. 6 shows an example of the user-related information displayed on the screen of the user terminal 10. The phone numbers 61 and 62 as identifiers used for search parameters, and the user-related information 63 and 64 as the search results are displayed. As the user-related information, real-time information such as the vacant seat information 66, an interactive content such as the Reserve button 67, and information belonging to an individual, such as the mail log 68, may be displayed at a time by using not only fixed information such as the user's e-mail address 65 but also a previously defined function. In this example, the phone numbers have already been registered because the search is executed with the address book. However, if the phone number obtained from the search result is not registered in the address book, a “Register search result with address book” button may be displayed.

To achieve the means and the functions that are described above, a computer (including CPU, an information processor, and various terminals) reads and executes a predetermined program. For example, a program is provided in a form recorded in a computer-readable recording medium such as a flexible disk, a CD (e.g., CD-ROM), and a DVD (e.g., DVD-ROM and DVD-RAM). In this case, a computer reads a program from the recording medium, forwards and stores the program to and in an internal or an external storage, and executes it. For example, the program may be previously recorded in memory (a recording medium) such as a magnetic disk, an optical disk, and a magnetic optical disk, and then provided from the memory to the computer through a communication line.

The embodiments of the present invention are described above. However, the present invention is not limited to these embodiments. In addition, the effects described in these embodiments merely illustrate the most preferable effects resulting from the present invention, and the effects according to the present invention are not limited to those described in these embodiments.

### REFERENCE SIGNS LIST

1 User-related information display system
3 Public network
10 User terminal
200 Reference server
250 User-related information database

What is claimed is:

1. A user terminal provided with a memory unit storing a user list and communicatively connected with a reference server provided with a user-related information database, comprising:
an identifier acquisition unit acquiring one or more user identifiers from the user list;
a user-related information acquisition unit acquiring user-related information associated and stored with the acquired identifiers or user-related information satisfying a user-related information search condition from the reference server; and
a user-related information display unit outputting the acquired user-related information to a display unit.

2. The user terminal according to claim 1, further comprising an identifier storing unit storing the identifier in the user list in the case in which the identifier associated with the acquired user-related information is not stored in the user list.

3. The user terminal according to claim 2, wherein the user list is an address book previously provided in the user terminal, and the identifier is any one of a name, a phone number, and an e-mail address associated and stored with the user.

4. The user terminal according to claim 3, further comprising:
a location information acquisition unit;
a display condition acquisition unit acquiring a display condition containing at least one of a location and a time previously set for each user-related information; and
a display condition determination unit determining if the location of the user terminal and the current time satisfies the display condition, wherein
the user-related information display unit outputs the user-related information to the display unit only when the display condition is satisfied.

5. The user terminal according to claim 1, wherein the user list is an address book previously provided in the user terminal, and the identifier is any one of a name, a phone number, and an e-mail address associated and stored with the user.

6. The user terminal according to claim 5, further comprising:
a location information acquisition unit;
a display condition acquisition unit acquiring a display condition containing at least one of a location and a time previously set for each user-related information; and
a display condition determination unit determining if the location of the user terminal and the current time satisfies the display condition, wherein
the user-related information display unit outputs the user-related information to the display unit only when the display condition is satisfied.

7. The user terminal according to claim 1, further comprising:
a location information acquisition unit;
a display condition acquisition unit acquiring a display condition containing at least one of a location and a time previously set for each user-related information; and
a display condition determination unit determining if the location of the user terminal and the current time satisfies the display condition, wherein
the user-related information display unit outputs the user-related information to the display unit only when the display condition is satisfied.

8. A user-related information display system comprising a user terminal provided with a memory unit storing a user list and a reference server provided with a user-related information database, the user terminal being communicatively connected with the reference server, wherein
the user terminal includes:
an identifier acquisition unit acquiring one or more user identifiers from the user list;
a user-related information acquisition unit acquiring the user-related information associated and stored with the acquired identifiers or user-related information satisfying a user-related information search condition from the reference server; and
a user-related information display unit outputting the acquired user-related information to the display unit; and
the reference server includes:
an extract parameter acquisition unit acquiring an extract parameter of the user-related information from the user terminal;
a user-related information extracting unit extracting user-related information from the user-related information database based on the acquired extract parameter; and
a user-related information transmitting unit transmitting the extracted user-related information to the user terminal.

9. A user-related information display method executed by a user terminal provided with a memory unit storing a user list and communicatively connected with a reference server provided with a user-related information database, comprising the steps of:
acquiring one or more user identifiers from the user list;
acquiring the user-related information associated and stored with the acquired identifiers or user-related information satisfying a user-related information search condition from the reference server; and
outputting the acquired user-related information to the display unit.

10. A computer program product for use in a user terminal provided with a memory unit storing a user list and communicatively connected with a reference server provided with a user-related information database, comprising a non-transitory computer usable medium having a set of instructions physically embodied therein, the set of instructions including computer readable program code, which when executed by the user terminal causes the information processing unit to:
acquire one or more user identifiers from the user list;
acquire the user-related information associated and stored with the acquired identifiers or user-related information satisfying a user-related information search condition from the reference server; and
output the acquired user-related information to the display unit.
